(19) United States
(12) Patent Application Publication
(10) Pub. No.: US 2026/0153715 A1
(43) Pub. Date: Jun. 4, 2026

(54) IMAGING OPTICAL SYSTEM

(71) Applicant: HUAWEI TECHNOLOGIES CO., LTD., Shenzhen (CN)

(72) Inventors: Uchida Tsuneo, Tokyo (JP); Gentaro Irisawa, Tokyo (JP); Sota Miyatani, Tokyo (JP); Lei Jiang, Shanghai (CN)

(73) Assignee: HUAWEI TECHNOLOGIES CO., LTD., Shenzhen (CN)

(21) Appl. No.: 19/455,662

(22) Filed: Jan. 21, 2026

Related U.S. Application Data
(63) Continuation of application No. PCT/CN2023/130582, filed on Nov. 9, 2023.

(51) Int. Cl. G02B 13/00; G02B 9/04

(52) U.S. Cl. CPC G02B 13/0065; G02B 9/04

(57) ABSTRACT

An imaging optical system comprising, from an object side to an image side along an optical axis: a first lens group; a prism comprising a light input surface at which the light that has passed through the first lens group is incident; a plurality of reflective surfaces that reflect the incident light; a light output surface from which the light reflected from the last reflective surface of the plurality of reflective surfaces is emitted, the plurality of reflective surfaces are arranged so that the chief ray incident from the light input surface is reflected multiple times within the prism so as to self-intersect a chief ray path at least once within the prism; a second lens group comprising at least one optical element having negative refractive power; an image sensor on which the light that has passed through the second lens group focuses images.

### CROSS-REFERENCE TO RELATED APPLICATIONS

This application is a continuation of International Application No. PCT/CN2023/130582, filed on Nov. 9, 2023, the disclosure of which is hereby incorporated by reference in its entirety.

### FIELD OF THE DISCLOSURE

The present disclosure relates to an imaging optical system. More specifically, the disclosure relates to an imaging optical system that generates an image of a subject on an individual image sensor such as a CCD or CMOS sensor, and in particular, to an imaging optical system photography device for portable devices represented by smartphones, game consoles, PCs, IP cameras, home appliances, automobiles, unmanned aerial vehicles, etc.

### BACKGROUND OF THE DISCLOSURE

With the popularization of smartphones in recent years, the needs for imaging lenses have diversified, and it is desirable to improve the optical performance while maintaining a compact module thickness, which is directly linked to product size, and to have wider angles, more telephoto lenses, and larger apertures. Nowadays, multi-camera systems with multiple imaging optical systems have become mainstream, and the role of telephoto lenses plays a major role in measuring differentiation in smartphone products since users can enjoy the experience of using telephoto lenses for photographing and viewing distant subjects, landscapes and celestial objects, etc.

Currently, the optical system used in such a telephoto lens module for smartphones uses a method in which a right-angle prism is used to bend the optical path to be parallel to the surface of the smartphone, with the aim of reducing the height of the body. However, the demand for miniaturization of telephoto lens modules continues to increase. A telephoto lens requires a longer optical path than a wide-angle lens, and this tendency becomes stronger as the optical magnification is increased, and this is a major factor in increasing the size and cost of small lens modules.

Telephoto optical systems, which are generally used for still images and videos, are currently of the periscope type, in which the optical path from the object is bent 90 degrees with a prism, with the aim of reducing the height of the unit for smartphones. In a telephoto optical system with a long focal length, the optical path length after bending by the prism is also long, so even if the lens module can be made thinner, it will be longer, and vise-versa. Such prisms are used in many compact telephoto camera modules. However, due to market demands and differentiation from competitors, the image sensor size of camera modules tends to increase year by year to prioritize image quality. Since the larger image sensors require a longer optical path, further miniaturization of lens modules is needed.

### SUMMARY OF THE DISCLOSURE

The present disclosure mitigates and/or obviates the aforementioned disadvantages.

The primary objective of the present disclosure is to provide an imaging optical system that has a first lens group, a prism, and a second lens group from the object side, and the light rays reflect at least twice inside the prism and self-intersect, thereby increasing the optical path length. In this disclosure, self-intersecting means that the optical paths intersect at least once inside the prism.

According to a first aspect of the present disclosure, a telephoto imaging system is provided. The telephoto imaging system comprises, from an object side to an image side along the optical axis, a first lens group comprising one or more optical elements, a prism that bends the optical path from the object side toward the image side, a second lens group comprising a plurality of optical elements, and an image sensor.

The chief ray from the object side passes through the first lens group and enters an light input surface of the prism. Then, the chief ray is reflected multiple times within the prism while intersecting itself (self-intersecting), and is emitted from a light output surface of the prism. Then, the chief ray emitted from the prism passes through the second lens group and focuses images at the center of the image sensor.

The most object side optical surface of the first lens group of the imaging optical system has a convex shape facing the object side. Further, the second lens group of the imaging optical system comprises at least one negative optical element.

In the present disclosure, unless otherwise specified, a negative/positive lens means that the focal length of the lens near the optical axis is negative/positive.

According to the telephoto imaging system of the first aspect of the present disclosure, a distance from the emitting surface of the prism to the image sensor can be shortened while maintaining high image quality by increasing the total length of the path of the chief ray in the prism by causing the chief ray incident from the light input surface of the prism to be reflected two or more times in the prism while intersecting itself and then being emitted from the light output surface of the prism.

The telephoto imaging system according to the present disclosure can achieve a desirable effect by satisfying the following conditions.

$$1 < F 1 / F 2 ≦ 10 \qquad ( i )$$

where F1 is a maximum luminous flux diameter at the most object side optical surface (convex surface) of the first lens group, wherein the light ray focuses images at the center of the image sensor, and F2 is a maximum luminous flux diameter at the most object side optical surface in the second lens group, wherein the light ray focuses images at the center of the image sensor.

$$\vert R 1 \vert < \vert R 2 \vert \qquad ( ii )$$

where R1 is a radius of curvature of an object side surface of the most object side optical element in the first lens group, and R2 is a radius of curvature of an image side surface of the most object side optical element in the first lens group.

$$0 ≦ D 1 / D 2 < 1 \qquad ( iii )$$

where D1 is a distance from the light input surface of the prism to the aperture stop, and D2 is a distance from the light output surface of the prism to the image sensor.

$$α / 2 < β \qquad ( iv )$$

where α is an angle between the optical axis of the first lens group and the optical axis of the second lens group, and β is an angle between the optical axis of the first lens group and a first reflective surface where the light incident from the light input surface is first reflected.

$$ν d > 50 \qquad ( v )$$

where νd is the Abbe number of the optical material of the most object side optical element of a first lens group.

$$FOV < 40 ° \qquad ( vi )$$

where FOV is a full angle of view when the object distance is infinite.

$$0.2 ≦ POR / f ≦ 2. \qquad ( vii )$$

where POR is a total path length (mm) within the prism from the light input surface to the light output surface along the chief ray that focuses images at the center of the image sensor, and f is a focal length (mm) of the imaging optical system.

$$0.5 ≦ ( POR / Pn ) / f ≦ 3. \qquad ( viii )$$

where POR is a total path length (mm) within a prism from a light input surface to a light output surface, through which the chief ray that focuses images at the center of the image sensor passes, and Pn is a refractive index of the prism.

$$1 ≦ L 1 a / Pa \qquad ( ix )$$

where L1a is the Abbe number of the most object side optical element in the first lens group, and Pa is the Abbe number of the prism

$$0.5 ≦ \vert L 1 f / Ff \vert ≦ 2.5 \qquad ( x )$$

where L1 is a focal length (mm) of the most object side optical element in the first lens group, and Ff is a focal length of a movable group (mm) when the first lens group or the second lens group consists of one movable lens group or one movable lens group and one fixed lens group, wherein the movable lens group is movable along the optical axis for focus adjustment.

$$0.2 ≦ LS / RS ≦ 1.5 \qquad ( xi )$$

where RS is a distance (mm) from the point where the chief rays self-intersect within the prism to the image sensor, and LS is a distance (mm) in the optical axis direction of the second Lens group from the light output surface to the point farthest from the image sensor in the effective area of the prism, which is used by the light rays focusing images at the center of the image sensor.

$$0.5 ≦ PL / LL ≦ 3.5 \qquad ( xii )$$

where LL is a distance (mm) in the optical axis direction of the second lens group from the light output surface to the image sensor, and PL is a distance (mm) in the optical axis direction of the second lens group from the light output surface to the point farthest from the image sensor in the effective area of the prism, which is used by the light rays focusing images at the center of the image sensor.

According to one aspect of the present telephoto imaging system, the optical element closest to the object side in the first lens group is formed of an optical material having an Abbe number νd>50.

According to one aspect of the present telephoto imaging system, the aperture stop is arranged parallel to the light input surface of the prism.

According to one aspect of the present telephoto imaging system, it is preferable that the aperture stop is disposed more toward the object side than the prism. Furthermore, it is preferable that the aperture stop is disposed on the most object-side optical surface (convex surface) of the first lens group.

According to one aspect of the present telephoto imaging system, the second lens group comprises at least one optical element having negative refractive power, and the most object-side optical surface of the second lens group has a concave surface facing the light output surface of the prism.

According to one aspect of the present telephoto imaging system, focus adjustment is possible by moving some of the optical elements in the optical axis direction.

According to one aspect of the present telephoto imaging system, the first lens group and/or the prism may be configured to be rotatable about at least one of the optical axis of the first lens group, the optical axis of the second lens group, and the axis perpendicular to the optical axes of the first and second lens groups.

The details and effects of these conditions will be described in the detailed descriptions below.

According to a second aspect of the present disclosure, a telephoto optical system is provided. The telephoto optical system comprises the telephoto optical system provided in the first aspect and an image sensor. The telephoto optical system is configured to input light, which is used to carry image data, to the image sensor, and the image sensor is configured to display an image according to the image data.

According to a third aspect, a terminal is provided. The terminal comprises a camera, which is the telephoto optical system provided in the second aspect, and a Graphic Processing Unit (GPU). The GPU is connected to the camera. The telephoto optical system is configured to obtain image data and input the image data into the GPU, and the GPU is configured to process the image data received from the telephoto optical system. The terminal can be applied to small telephoto optical system for mobile devices such as mobile phones and tablets.

By using such an imaging optical system, it is possible to resolve the above-mentioned problems by providing a telephoto lens module with a further reduced overall optical length and thickness while maintaining good optical performance.

The present disclosure will be presented in further detail based on the following descriptions with accompanying drawings, which show, for the purpose of illustration only, the preferred embodiments in accordance with the present disclosure.

### BRIEF DESCRIPTION OF THE DRAWINGS

The disclosure can be better understood from the following detailed description of non-limiting embodiments thereof, and by examining the accompanying drawings, in which:

FIG. 1-1 shows a cross-sectional view along the chief ray of a telephoto imaging system according to a first embodiment of the present disclosure.

FIG. 1-2 shows a top view and a perspective view of the telephoto imaging system according to the first embodiment of the present disclosure.

FIG. 1-3 shows a longitudinal spherical aberration of the telephoto imaging system according to the first embodiment of the present disclosure.

FIG. 1-4 shows a field curvature of the telephoto imaging system according to the first embodiment of the present disclosure.

FIG. 1-5 shows a distortion aberration of the telephoto imaging system according to the first embodiment of the present disclosure.

FIG. 2-1 shows a cross-sectional view along the chief ray of a telephoto imaging system according to a second embodiment of the present disclosure.

FIG. 2-2 shows a longitudinal spherical aberration of the telephoto imaging system according to the second embodiment of the present disclosure.

FIG. 2-3 shows a field curvature of the telephoto imaging system according to the second embodiment of the present disclosure.

FIG. 2-4 shows a distortion aberration of the telephoto imaging system according to the second embodiment of the present disclosure.

FIG. 3-1 shows a cross-sectional view along the chief ray of a telephoto imaging system according to a third embodiment of the present disclosure.

FIG. 3-2 shows a perspective view of the telephoto imaging system according to the third embodiment of the present disclosure.

FIG. 3-3 shows a longitudinal spherical aberration of the telephoto imaging system according to a third embodiment of the present disclosure.

FIG. 3-4 shows a field curvature of the telephoto imaging system according to the third embodiment of the present disclosure.

FIG. 3-5 shows a distortion aberration of the telephoto imaging system according to the third embodiment of the present disclosure.

FIG. 4-1 shows a cross-sectional view along the chief ray of a telephoto imaging system according to a fourth embodiment of the present disclosure.

FIG. 4-2 shows a spherical aberration of the telephoto imaging system according to the fourth embodiment of the present disclosure.

FIG. 4-3 shows a field curvature of the telephoto imaging system according to the fourth embodiment of the present disclosure.

FIG. 4-4 shows a distortion aberration of the telephoto imaging system according to the fourth embodiment of the present disclosure.

FIG. 5-1 shows a reference diagram illustrating a maximum luminous flux diameter F1 at the most object side optical surface (convex surface) of the first lens group, wherein the light ray focuses images at the center of the image sensor, and a maximum luminous flux diameter F2 at the most object side optical surface in the second lens, wherein the light ray focuses images at the center of the image sensor, in the present disclosure.

FIG. 5-2 shows a reference diagram illustrating a distance D1 from the light input surface of the prism to the aperture stop, and a distance D2 from the light output surface of the prism to the image sensor, in the present disclosure.

FIG. 5-3 shows a reference diagram illustrating an angle α between the optical axis of the first lens group and the optical axis of the second lens group, and an angle β between the optical axis of the first lens group and a first reflective surface where the light incident from the light input surface is first reflected, in the present disclosure.

FIG. 5-4 shows a reference diagram illustrating a total path length POR (mm) within the prism from the light input surface to the light output surface along the chief ray that focuses images at the center of the image sensor, and a focal length f (mm) of the imaging optical system, in the present disclosure.

FIG. 5-5 shows a reference diagram illustrating a distance RS (mm) from the point where the chief rays self-intersect within the prism to the image sensor, and a distance LS (mm) in the optical axis direction of the second lens group from the light output surface to the point farthest from the image sensor in the effective area of the prism, which is used by the light rays focusing images at the center of the image sensor, in the present disclosure.

FIG. 5-6 shows a reference diagram illustrating a distance LL (mm) in the optical axis direction of the second lens group from the light output surface to the image sensor, and a distance PL (mm) in the optical axis direction of the second lens group from the light output surface to the point farthest from the image sensor in the effective area of the prism, which is used by the light rays focusing images at the center of the image sensor, in the present disclosure.

FIG. 6 shows an implementation of the present disclosure.

### DETAILED DESCRIPTION OF THE PREFERRED EMBODIMENTS

The following embodiments of the telephoto imaging system of the present disclosure will be described below with reference to figures and optical data. The telephoto imaging system may be applied to small cameras for mobile devices such as mobile phones and tablet terminals.

In the present disclosure, the term “optical axis” refers to an axis connecting the symmetrical axes of rotationally symmetrical optical surfaces of all optical elements in each lens group. Alternatively, the optical axis may be an axis connecting the symmetrical axes of rotationally symmetrical optical surfaces of any one of optical elements in each lens group.

A telephoto imaging system according to the present disclosure comprises, in order from an object side along the optical axis, a first lens group, a prism that bends light incident from the first lens group, a second lens group, and an image sensor. The chief ray that enters the prism from the first lens group is reflected multiple times within the prism, self-intersects, and is emitted from the light output surface of the prism to the second lens group.

### First Embodiment

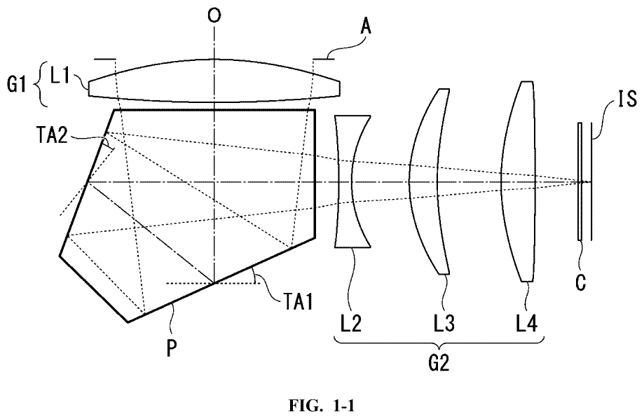

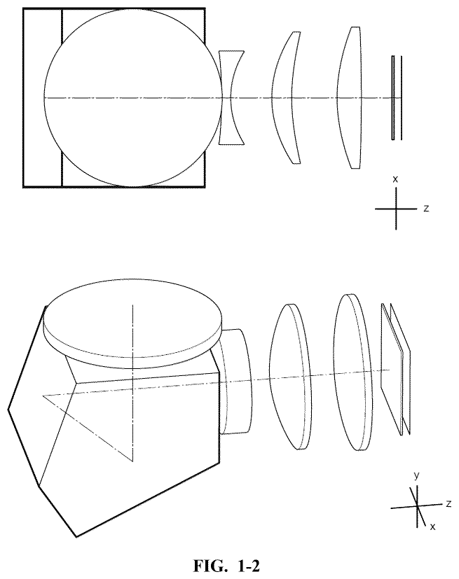

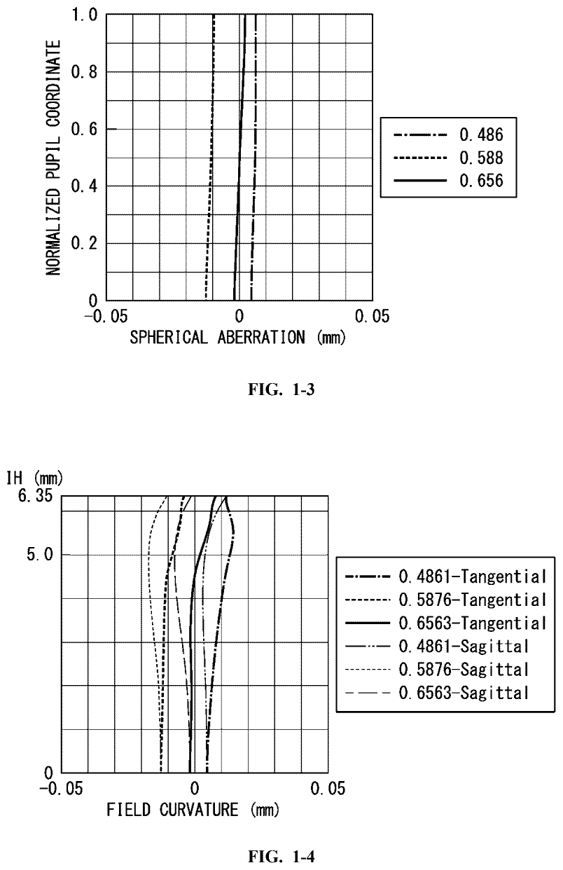

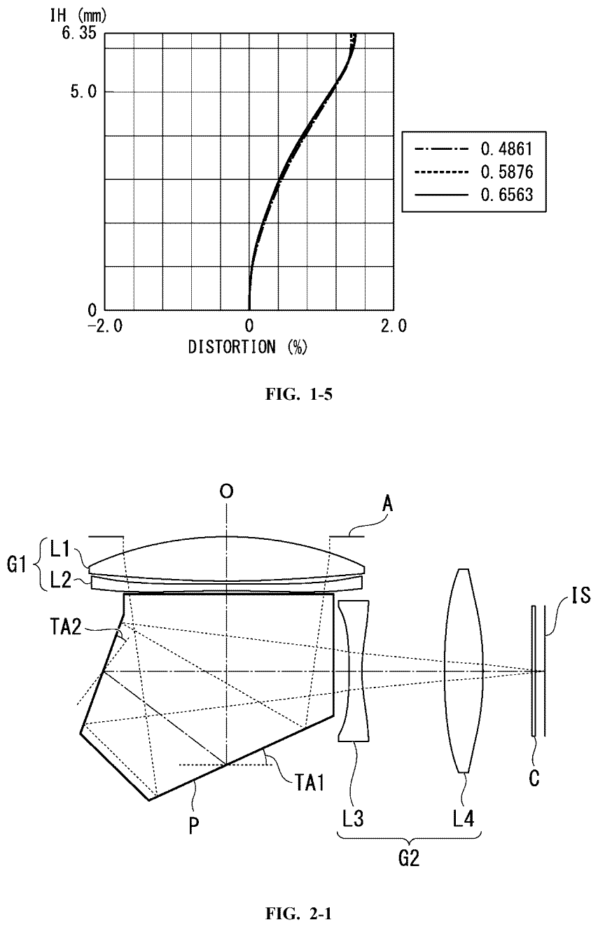

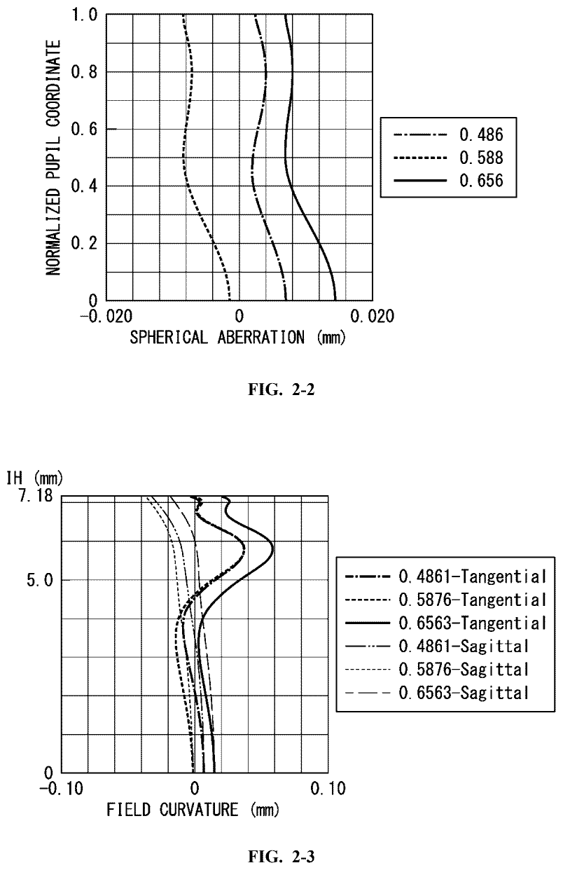

FIG. 1-1 shows a cross-sectional view along the chief optical axis of a telephoto imaging system according to a first embodiment of the present disclosure, which is depicted three-dimensionally in FIG. 1-2.

The telephoto imaging system comprises, from the object side to the image side along the optical axis, an aperture stop A, a first optical element L1, a prism P that bends the optical path from the object side toward the image side, a second optical element L2, a third optical element L3, a fourth optical element, and an image sensor IS. Here, a first lens group G1 consists of the first optical element L1, and a second lens group G2 consists of the second optical element L2, the third optical element L3, and the fourth optical element L4. An optical filter C such as an infrared cut filter or a cover glass may be arranged on the image sensor IS. The optical filter C may also be omitted.

In the telephoto imaging system according to the first embodiment, the optical surface closest to the object side in the first lens group G1 is a convex surface. The object-side optical surface of the second optical element L2 of the second lens group G2 is a concave surface. The focus adjustment is performed by moving the third optical element L3 and the fourth optical element L4 together along the optical axis of the second lens group. The optical axis of the second lens group is the z-axis in FIG. 1-2, and the optical axis of the first lens group is the y-axis.

The chief ray from the object passes through the first lens element L1, and enters the light input surface of the prism P. Then, the chief ray is reflected at a first reflective surface of the prism P at an angle of TA1, and then at a second reflective surface of the prism P at an angle of TA2. After being reflected at the second reflective surface of the prism P, the chief ray self-intersects the chief ray path and is emitted from the output surface of the prism P. In this disclosure, the expression “self-intersects” means that the optical path of the chief ray intersects itself at least once within the prism. The chief ray emitted from the prism P sequentially passes through the second optical element L2 and the third optical element L3, and focuses images at the center of the image sensor IS. TA is the angle of the reflective surface with respect to a plane perpendicular to the optical axis incident on the reflective surface, as shown in FIG. 1-1.

The first lens group G1 of the imaging optical system comprises the first optical element L1. The first optical element L1 is a biconvex lens.

The second lens group G2 of the imaging optical system comprises the second optical element L2, the third optical element L3, and the fourth optical element L4. The second optical element L2 is a biconcave lens. By applying an aspherical surface to the second optical element L2 and having a shape with a concave surface facing the object side, field curvature at the periphery of the image can be corrected satisfactorily. The third optical element L3 is a positive meniscus lens with a convex surface facing the object side. The fourth optical element L4 is a biconvex lens.

The light input surface, the first reflective surface, the second reflective surface, and the light output surface of the prism P are all formed of flat surfaces in the first embodiment. The first reflective surface and the second reflective surface of the prism P may be formed of a metal (aluminum, silver, etc.) reflective film, a dielectric multilayer film, a metal reflective film with reflective coatings, or the like.

In the first embodiment, the chief ray entering from the light input surface of the prism P is reflected twice within the prism, then self-intersects and is emitted from the light output surface, thereby resulting in a longer path of the chief ray within the prism. By increasing the total length within the prism, the distance from the light output surface of the prism to the image sensor can be shortened while maintaining high image quality.

Table 1-1 shows the radius of curvature and the thickness or separation for each of the optical surfaces, and the refractive index and the Abbe number with respect to the d line for each of the lens elements of the optical lens system in accordance with the first embodiment. Opposing surfaces of each lens element are respectively referred to as surface S1 and surface S2 in order from the object side to the image side. The opposing surfaces of the first optical element L1, the opposing surfaces of the second optical element L2, the opposing surfaces of the third optical element L3, and the opposing surfaces of the fourth optical element L4 are aspherical. Further, in the first optical element L1, the absolute value of the radius of curvature of the object side surface S1 is smaller than the absolute value of the radius of curvature of the image side surface S2.

TABLE 1-1

| | | | | | | | | Clear | | |
|---|---|---|---|---|---|---|---|---|---|---|
| | | Surface | | | | | | Aperture | | Tilt |
| Lens | Surface | Type | Radius | Distance | Macro | Index | Abbe | X | Y | Angle |
| STO | | | INF | 0.000 | | | | 5.000 | 4.000 | |
| L1 | S1 | Aspherical | 14.321 | 1.797 | | 1.545 | 55.987 | 5.083 | 4.039 | |
| | S2 | Aspherical | −44.756 | 0.370 | | | | 5.037 | 3.976 | |
| Prism | S1 | Transmissive | INF | 7.300 | | 1.752 | 25.048 | 4.928 | 3.902 | |
| | S2 | Reflective | INF | −6.700 | | | | 4.235 | 3.816 | 25.0 |
| | S3 | Reflective | INF | 9.200 | | | | 3.586 | 3.078 | 20.0 |
| | S4 | Transmissive | INF | 1.000 | | | | 2.681 | 2.092 | |
| L2 | S1 | Aspherical | −23.919 | 0.506 | | 1.651 | 21.545 | 2.787 | 2.774 | |
| | S2 | Aspherical | 5.228 | 2.346 | 0.997 | | | 2.761 | 2.749 | |
| L3 | S1 | Aspherical | 6.519 | 1.130 | | 1.545 | 55.987 | 3.920 | 3.920 | |
| | S2 | Aspherical | 11.933 | 2.598 | | | | 3.919 | 3.919 | |
| L4 | S1 | Aspherical | 9.472 | 1.371 | | 1.651 | 21.545 | 4.220 | 4.220 | |
| | S2 | Aspherical | 119.151 | 1.767 | 3.117 | | | 4.176 | 4.176 | |
| Corver | S1 | | INF | 0.110 | | 1.513 | 54.000 | 3.076 | 2.309 | |
| Glass | S2 | | INF | 0.410 | | | | 3.062 | 2.299 | |

| | | | | |
|---|---|---|---|---|
| Image Surface | INF | 0.000 | 2.988 | 2.241 |

Table 1-2 shows the aspheric coefficients for each of the lens elements of the optical lens system in accordance with the first embodiment, wherein numbers 4, 6, . . . , 12 represent the higher order aspheric coefficients. The equation of the aspheric surface profiles is expressed as follows:

$$z = \frac{{cH}^{2}}{1 + \sqrt{1 - ( 1 + k ) {c}^{2} {H}^{2}}} + {A}_{4} {H}^{4} + {A}_{6} {H}^{6} + {A}_{8} {H}^{8} + {A}_{10} {H}^{10} + {A}_{12} {H}^{12}$$

wherein,
z: the distance (sag amount) in the optical axis direction from the apex of the lens surface;
H: the height in the direction perpendicular to the optical axis direction;
c: paraxial curvature at the apex of the lens (reciprocal of radius of curvature);
Y: the distance from a point on the curve of the aspheric surface to the optical axis;
k: the conic coefficient; and
Ai: the aspheric coefficient of order i.

TABLE 1-2

| | | Aspherical | | | | | |
|---|---|---|---|---|---|---|---|
| Lens | Surface | K | 4th | 6th | 8th | 10th | 12th |
| L1 | S1 | 0.00E+00 | −1.0600E−05 | 1.9300E−07 | −9.0400E−09 | 2.2500E−10 | 0.0000E+00 |
| | S2 | 0.00E+00 | 3.1900E−05 | 1.6000E−07 | −9.1000E−09 | 2.2400E−10 | 0.0000E+00 |
| L2 | S1 | 0.00E+00 | 7.4100E−04 | −2.3600E−04 | 2.0500E−05 | −7.5800E−07 | 0.0000E+00 |
| | S2 | 0.00E+00 | 9.0400E−04 | −2.6500E−04 | 2.0600E−05 | −7.8900E−07 | 0.0000E+00 |
| L3 | S1 | 0.00E+00 | −2.5100E−04 | −4.5900E−05 | 4.1800E−06 | −1.3200E−07 | 0.0000E+00 |
| | S2 | 0.00E+00 | −6.2800E−04 | −5.0300E−05 | 5.8900E−06 | −1.8300E−07 | 0.0000E+00 |
| L4 | S1 | 0.00E+00 | −5.5300E−04 | −1.0200E−05 | 2.2700E−07 | 2.1600E−08 | 0.0000E+00 |
| | S2 | 0.00E+00 | −5.9900E−04 | −1.7500E−06 | −2.3900E−07 | 3.8700E−08 | 0.0000E+00 |

FIG. 1-3 shows a longitudinal spherical aberration for each wavelength in the imaging optical system according to the first embodiment of the present disclosure. The first embodiment in this disclosure are designed with well-corrected spherical aberration and sufficiently suppressed axial chromatic aberration.

FIG. 1-4 shows a field curvature where the amount of d-line aberration on the sagittal image plane S and the amount of d-line aberration on the tangential image plane T are shown by a different line in the imaging optical system according to the first embodiment of the present disclosure. The field curvature is also well corrected in both the sagittal and tangential image planes.

FIG. 1-5 shows a distortion aberration with the amount of aberration for each wavelength. It shows that the distortion is also minimized. From these figures, it can be seen that each aberration is satisfactorily corrected.

### Second Embodiment

FIG. 2-1 shows a cross-sectional view along the chief optical axis of a telephoto imaging system according to a second embodiment of the present disclosure.

The telephoto imaging system comprises, from the object side to the image side along the optical axis, an aperture stop A, a first optical element L1, a second optical element L2, a prism P that bends the optical path from the object side toward the image side, a third optical element L3, a fourth optical element L4, and an image sensor IS. Here, a first lens group G1 consists of the first optical element L1 and the second lens element L2, and a second lens group G2 consists of the third optical element L3 and the fourth optical element L4. An optical filter C such as an infrared cut filter or a cover glass may be arranged on the image sensor IS. The optical filter C may also be omitted.

In the telephoto imaging system according to the second embodiment, the optical surface closest to the object side of the first lens group G1 is a convex surface. Further, the object-side optical surface of the third optical element L3 of the second lens group G2 is a concave surface. The focus adjustment is performed by moving the fourth optical element L4 the optical axis of the second lens group.

The chief ray from the object passes through the first lens element L1, and enters the light input surface of the prism P. Then, the chief ray is reflected at a first reflective surface of the prism P at an angle of TA1, and then at a second reflective surface of the prism P at an angle of TA2. After being reflected at the second reflective surface of the prism P, the chief ray self-intersects the chief ray path and is emitted from the output surface of the prism P. The chief ray emitted from the prism P sequentially passes through the third optical element L3 and the fourth optical element L4, and focuses images at the center of the image sensor IS. TA is the angle of the reflective surface with respect to a plane perpendicular to the optical axis incident on the reflective surface, as shown in FIG. 2-1.

The first lens group G1 of the imaging optical system consists of the first optical element L1 and the second optical element L2. The first optical element L1 is a biconvex lens. The second optical element L2 is a negative meniscus lens with a convex surface facing the object near the optical axis. However, for the entire effective diameter, the second optical element L2 has an aspherical shape with a concave surface facing the object at the periphery part of the effective diameter.

The second lens group G2 of the imaging optical system consists of the third optical element L3 and the fourth optical element L4. The third optical element L3 is a negative meniscus lens with a convex surface facing the object near the optical axis. However, for the entire effective diameter, the third optical element L3 has an aspherical shape with a concave surface facing the object at the peripheral part of the effective diameter. By applying an aspherical surface to the third optical element L3 and making a shape with a concave surface oriented toward the object as the entire effective diameter, image curvature at the periphery of the image can be corrected satisfactorily. The fourth optical element L4 is a biconvex lens.

The light input surface, the first reflective surface, the second reflective surface, and the light output surface of the prism P are all formed of flat surfaces in the second embodiment. Further, the first reflective surface and the second reflective surface of the prism P may be formed of a metal (aluminum, silver, etc.) reflective film, a dielectric multilayer film, a metal reflective film with reflective coatings, or the like.

In the second embodiment, the chief ray entering from the light input surface of the prism P is reflected twice within the prism, then self-intersects and is emitted from the light output surface, thereby resulting in a longer path of the chief ray within the prism. By increasing the total length within the prism, the distance from the light output surface of the prism to the image sensor can be shortened while maintaining high image quality.

By arranging the second optical element L2 with negative refractive power between the first optical element L1 of the first lens group G1 and the prism P, chromatic aberration can be corrected by the first optical element L1 and the second optical element L2 before light enters the prism P. This is expected to shorten the overall length of the optical system and reduce the number of optical elements within the second lens group G2.

Table 2-1 shows the radius of curvature and the thickness or separation for each of the optical surfaces, and the refractive index and the Abbe number with respect to the d line for each of the lens elements of the optical lens system in accordance with the second embodiment. Opposing surfaces of each lens element are respectively referred to as surface S1 and surface S2 in order from the object side to the image side. The opposing surfaces of the first optical element L1, the opposing surfaces of the second optical element L2, the opposing surfaces of the third optical element L3, and the opposing surfaces of the fourth optical element L4 are aspherical. Further, in the first optical element L1, the absolute value of the radius of curvature of the object side surface S1 is smaller than the absolute value of the radius of curvature of the image side surface S2.

TABLE 2-1

| | | | | | | | | Clear | | |
|---|---|---|---|---|---|---|---|---|---|---|
| | | Surface | | | | | | Aperture | | Tilt |
| Lens | Surface | Type | Radius | Distance | Macro | Index | Abbe | X | Y | Angle |
| STO | | | INF | 0.000 | | | | 5.390 | 4.040 | |
| L1 | S1 | Aspherical | 12.509 | 1.819 | | 1.569 | 71.341 | 5.392 | 4.044 | |
| | S2 | Aspherical | −43.386 | 0.100 | | | | 5.339 | 3.928 | |
| L2 | S1 | Aspherical | 72.775 | 0.300 | | 1.671 | 19.276 | 5.302 | 3.879 | |
| | S2 | Aspherical | 33.014 | 0.150 | | | | 5.240 | 3.838 | |
| Prism | S1 | Transmissive | INF | 7.025 | | 1.518 | 58.961 | 5.179 | 3.815 | |
| | S2 | Reflective | INF | −6.191 | | | | 3.934 | 3.427 | 25.6 |
| | S3 | Reflective | INF | 9.044 | | | | 2.950 | 2.400 | 19.4 |
| | S4 | Transmissive | INF | 0.597 | | | | 2.404 | 1.869 | |
| L3 | S1 | Aspherical | 88.402 | 0.500 | | 1.735 | 48.782 | 2.679 | 2.679 | |
| | S2 | Aspherical | 5.436 | 3.240 | 1.000 | | | 2.881 | 2.881 | |
| L4 | S1 | Aspherical | 22.470 | 1.526 | | 1.545 | 55.987 | 4.132 | 4.132 | |
| | S2 | Aspherical | −13.384 | 1.910 | 4.150 | | | 4.180 | 4.180 | |
| Corver | S1 | | INF | 0.110 | | 1.512 | 55.707 | 3.365 | 2.524 | |
| Glass | S2 | | INF | 0.410 | | | | 3.363 | 2.522 | |

| | | | | |
|---|---|---|---|---|
| Image Surface | INF | 0.000 | 3.351 | 2.512 |

Table 2-2 shows the aspheric coefficients for each of the lens elements of the optical lens system in accordance with the second embodiment, wherein numbers 4, 6, . . . , 12 represent the higher order aspheric coefficients.

TABLE 2-2

| | | Aspherical | | | | | |
|---|---|---|---|---|---|---|---|
| Lens | Surface | K | 4th | 6th | 8th | 10th | 12th |
| L1 | S1 | 0.00E+00 | −5.4800E−05 | 1.6000E−06 | 1.2700E−08 | −5.0500E−10 | 1.8800E−11 |
| | S2 | 0.00E+00 | −3.0145E−05 | 2.6883E−06 | −2.0011E−08 | 2.8059E−10 | 8.8223E−12 |
| L2 | S1 | 0.00E+00 | −1.0168E−03 | 1.4592E−05 | 0.0000E+00 | 0.0000E+00 | 0.0000E+00 |
| | S2 | 0.00E+00 | −1.0538E−03 | 1.4776E−05 | 0.0000E+00 | 0.0000E+00 | 0.0000E+00 |
| L3 | S1 | 0.00E+00 | −1.7729E−02 | 1.9242E−03 | −9.3370E−05 | −3.6999E−06 | 4.3706E−07 |
| | S2 | 0.00E+00 | −1.8797E−02 | 2.5251E−03 | −2.2859E−04 | 1.0990E−05 | −1.9887E−07 |
| L4 | S1 | 0.00E+00 | −4.2627E−05 | 1.3614E−04 | −1.7270E−05 | 1.2365E−06 | −3.3542E−08 |
| | S2 | 0.00E+00 | −9.4548E−04 | 2.1825E−04 | −2.4662E−05 | 1.6993E−06 | −4.4603E−08 |

FIG. 2-2 shows a longitudinal spherical aberration for each wavelength in the imaging optical system according to the second embodiment of the present disclosure. The second embodiment in this disclosure are designed with well-corrected spherical aberration and sufficiently suppressed axial chromatic aberration.

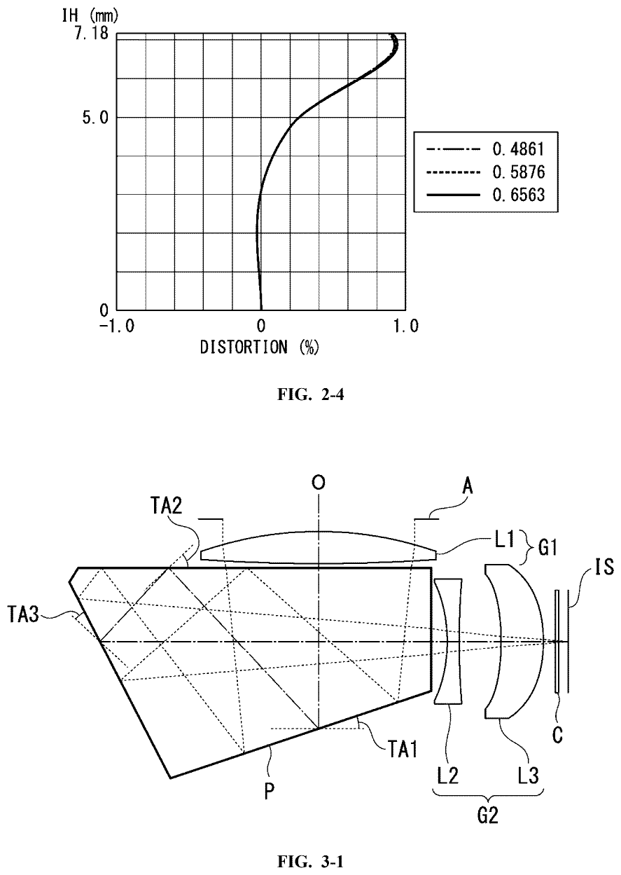

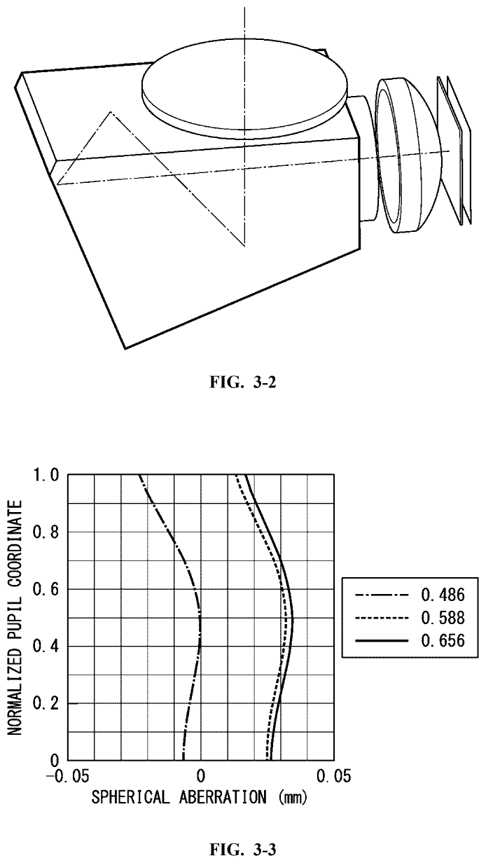

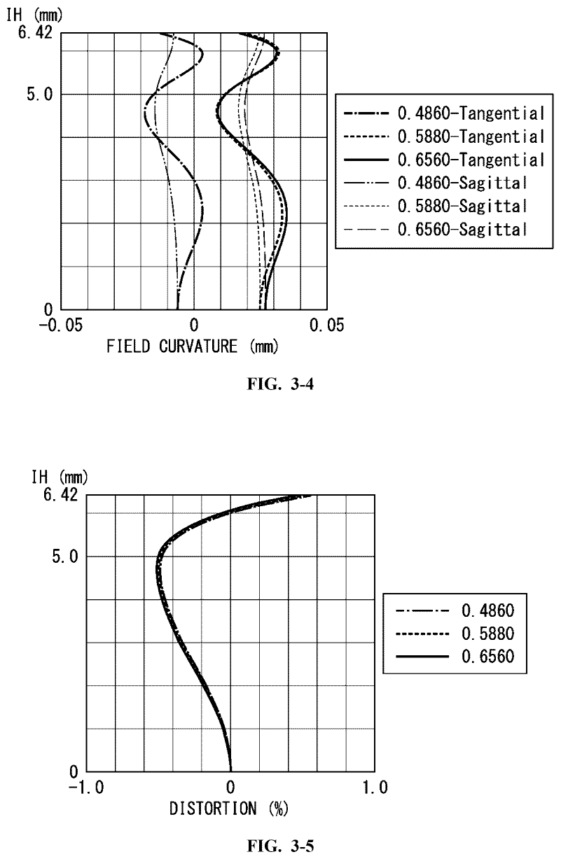

FIG. 2-3 shows a field curvature where the amount of d-line aberration on the sagittal image plane S and the amount of d-line aberration on the tangential image plane T are shown by a different line in the imaging optical system according to the second embodiment of the present disclosure. The field curvature is also well corrected in both the sagittal and tangential image planes.

FIG. 2-4 shows a distortion aberration with the amount of aberration for each wavelength. It shows that the distortion is also minimized. From these figures, it can be seen that each aberration is satisfactorily corrected.

### Third Embodiment

FIG. 3-1 shows a cross-sectional view along the chief optical axis of a telephoto imaging system according to a third embodiment of the present disclosure, which is depicted three-dimensionally in FIG. 3-2.

The telephoto imaging system comprises, from the object side to the image side along the optical axis, an aperture stop A, a first optical element L1, a prism P that bends the optical path from the object side toward the image side, a second optical element L2, a third optical element L3 and an image sensor IS. Here, the first lens group G1 consists of the first optical element L1, and the second lens group G2 consists of the second optical element L2 and the third optical element L3. An optical filter C such as an infrared cut filter or a cover glass may be arranged on the image sensor IS. The optical filter C may also be omitted.

In the telephoto imaging system according to the third embodiment, the optical surface closest to the object side of the first lens group G1 is a convex surface. The object-side optical surfaces of the second optical element L2 and the third optical element L3 of the second lens group G2 are concave. By applying an aspherical surface to the second optical element L2 and making a concave surface oriented toward the object side, image curvature at the periphery of the image can be corrected satisfactorily. The focus adjustment is performed by moving the first optical element L1 along the optical axis.

The chief ray from the object passes through the first lens element L1, and enters the light input surface of the prism P. Then, the chief ray is reflected at a first reflective surface of the prism P at an angle of TA1, then at a second reflective surface of the prism P at an angle of TA2, and then at a third reflective surface of the prism P at an angle of TA3. After being reflected at the third reflective surface, the chief ray self-intersects the chief ray path and is emitted from the light output surface. The chief ray emitted from the light output surface of the prism P sequentially passes through the second optical element L2 and the third optical element L3, and focuses images at the center of the image sensor IS. TA is the angle of the reflective surface with respect to a plane perpendicular to the optical axis incident on the reflective surface, as shown in FIG. 3-1. In the third embodiment, the light input surface and the second reflective surface are the same surface.

The first lens group G of the imaging optical system consists of the first optical element L1. The first optical element L1 is a biconvex lens.

The second lens group G2 of the imaging optical system consists of the second optical element L2 and the third optical element L3. The second optical element L2 is a biconcave lens. The third optical element L3 is a positive meniscus lens with a concave surface facing the object side.

The light input surface (the second reflective surface), the first reflective surface, the third reflective surface, and the light output surface of the prism P are all formed of flat surfaces. Further, the first reflective surface and the second reflective surface of the prism P may be formed of a metal (aluminum, silver, etc.) reflective film, a dielectric multilayer film, a metal reflective film with reflective coatings, or the like. The second reflective surface of the prism P is the same plane as the incident surface, and a part or all of its planes are used to guide the light incident on the second reflective surface to the third reflective surface by total reflection.

In the third embodiment, the chief ray entering from the light input surface of the prism P is reflected three times within the prism P, then self-intersects and is emitted from the light output surface, thereby resulting in a longer path of the chief ray within the prism. By increasing the total length within the prism, the distance from the light output surface of the prism to the image sensor can be shortened while maintaining high image quality.

Table 3-1 shows the radius of curvature and the thickness or separation for each of the optical surfaces, and the refractive index and the Abbe number with respect to the d line for each of the lens elements of the optical lens system in accordance with the third embodiment. Opposing surfaces of each lens element are respectively referred to as surface S1 and surface S2 in order from the object side to the image side. The opposing surfaces of the first optical element L1, the opposing surfaces of the second optical element L2, and the opposing surfaces of the third optical element L3 are aspherical. Further, in the first optical element L1, the absolute value of the radius of curvature of the object side surface S1 is smaller than the absolute value of the radius of curvature of the image side surface S2.

TABLE 3-1

| | | | | | | | | Clear | | |
|---|---|---|---|---|---|---|---|---|---|---|
| | | Surface | | | | | | Aperture | | Tilt |
| Lens | Surface | Type | Radius | Distance | Macro | Index | Abbe | X | Y | Angle |
| STO | | | INF | 0.600 | 0.068 | | | 5.000 | 4.000 | |
| L1 | S1 | Aspherical | 14.036 | 1.493 | | 1.497 | 81.560 | 5.004 | 4.003 | |
| | S2 | Aspherical | −64.951 | 0.200 | 0.732 | | | 4.956 | 3.927 | |
| Prism | S1 | Transmissive | INF | 7.500 | | 1.911 | 35.250 | 4.867 | 3.868 | |
| | S2 | Reflective | INF | −9.800 | | | | 4.020 | 3.510 | −20.0 |
| | S3 | Reflective | INF | 4.500 | | | | 3.480 | 3.765 | 40.0 |
| | S4 | Reflective | INF | −14.000 | | | | 3.220 | 2.962 | 25.0 |
| | S5 | Transmissive | INF | −0.657 | | | | 2.412 | 1.895 | |
| L2 | S1 | Aspherical | 7.451 | −0.500 | | 1.651 | 21.545 | 2.775 | 2.775 | |
| | S2 | Aspherical | −89.411 | −1.763 | | | | 2.921 | 2.921 | |
| L3 | S1 | Aspherical | 11.944 | −1.775 | 0.000 | 1.545 | 55.987 | 3.181 | 3.181 | |
| | S2 | Aspherical | 7.566 | −0.522 | | | | 3.600 | 3.600 | |
| Corver | S1 | | INF | −0.110 | | 1.512 | 55.707 | 2.992 | 2.247 | |
| Glass | S2 | | INF | −0.410 | | | | 2.992 | 2.246 | |

| | | | | |
|---|---|---|---|---|
| Image Surface | INF | 0.000 | 2.991 | 2.243 |

Table 3-2 shows the aspheric coefficients for each of the lens elements of the optical lens system in accordance with the third embodiment, wherein numbers 4, 6, . . . , 12 represent the higher order aspheric coefficients.

TABLE 3-2

| | | Aspherical | | | | | |
|---|---|---|---|---|---|---|---|
| Lens | Surface | K | 4th | 6th | 8th | 10th | 12th |
| L1 | S1 | 0.00000E+00 | −6.44643E−06 | −6.68269E−07 | 1.85456E−08 | 0.00000E+00 | 0.00000E+00 |
| | S2 | 0.00000E+00 | 2.14465E−05 | −5.17645E−07 | 1.65946E−08 | 0.00000E+00 | 0.00000E+00 |
| L2 | S1 | 0.0000E+00 | −6.5250E−04 | 1.0182E−04 | 0.0000E+00 | 0.0000E+00 | 0.0000E+00 |
| | S2 | 0.0000E+00 | −1.5510E−03 | 8.7515E−05 | 0.0000E+00 | 0.0000E+00 | 0.0000E+00 |
| L3 | S1 | 0.0000E+00 | −2.6695E−04 | 2.6260E−04 | 0.0000E+00 | 0.0000E+00 | 0.0000E+00 |
| | S2 | 0.0000E+00 | 1.7566E−03 | 1.1605E−04 | 0.0000E+00 | 0.0000E+00 | 0.0000E+00 |

FIG. 3-3 shows a longitudinal spherical aberration for each wavelength in the imaging optical system according to the third embodiment of the present disclosure. The third embodiment in this disclosure are designed with well-corrected spherical aberration and sufficiently suppressed axial chromatic aberration.

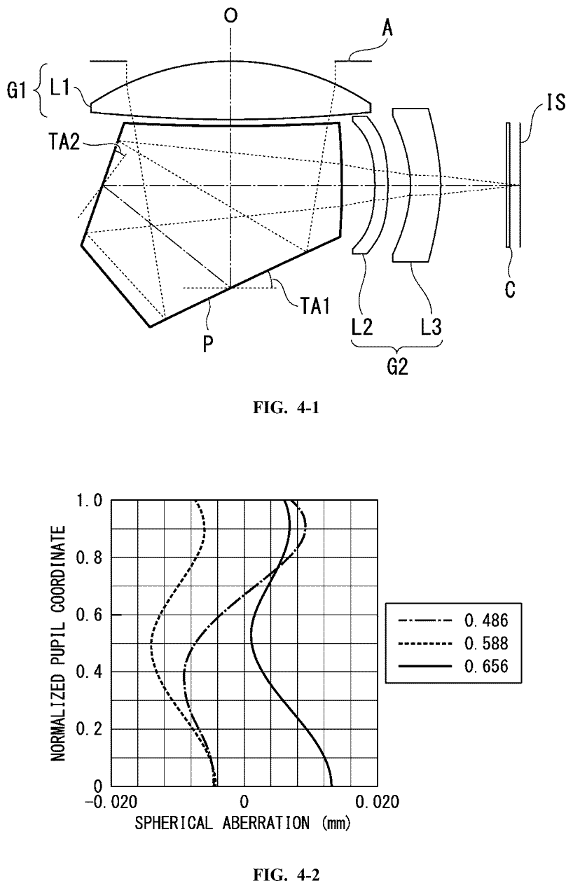

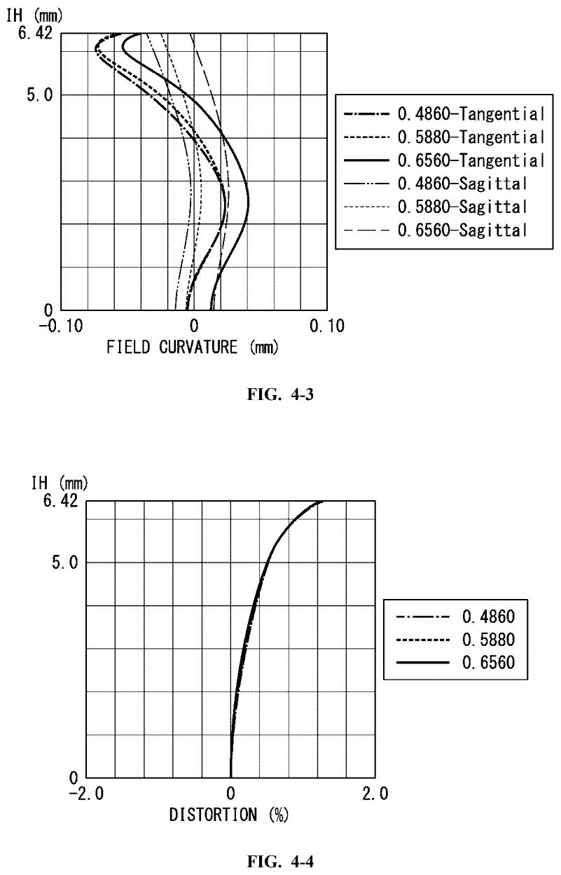

FIG. 3-4 shows a field curvature where the amount of d-line aberration on the sagittal image plane S and the amount of d-line aberration on the tangential image plane T are shown by a different line in the imaging optical system according to the third embodiment of the present disclosure. The field curvature is also well corrected in both the sagittal and tangential image planes.

FIG. 3-5 shows a distortion aberration with the amount of aberration for each wavelength. It shows that the distortion is also minimized. From these figures, it can be seen that each aberration is satisfactorily corrected.

### Fourth Embodiment

FIG. 4-1 shows a cross-sectional view along the chief optical axis of a telephoto imaging system according to a fourth embodiment of the present disclosure.

The telephoto imaging system comprises, from the object side to the image side along the optical axis, an aperture stop A, a first optical element L1, a prism P that bends the optical path from the object side toward the image side, a second optical element L2, a third optical element L3, and an image sensor IS. Here, the first lens group G1 consists of the first lens element L1, and the second lens group G2 consists of the second optical element L2 and the third optical element L3. An optical filter C such as an infrared cut filter or a cover glass may be arranged on the image sensor IS. The optical filter C may also be omitted.

In the telephoto imaging system according to the fourth embodiment, the most object side optical surface in the first lens group G1 is a convex surface. The object-side optical surfaces of the second optical element L2 and the third optical element L3 of the second lens group G2 are concave surfaces. The focus adjustment is performed by moving the third optical element L3 along the optical axis.

The chief ray from the object passes through the first lens element L1, and enters a light input surface of the prism P. Then, the chief ray is reflected at a first reflective surface of the prism P at an angle of TA1, and then at a second reflective surface at an angle of TA2. After being reflected at the second reflective surface of the prism P, the chief ray self-intersects a chief ray path and is emitted from a light output surface of the prism P. The chief ray emitted from the prism P sequentially passes through the second optical element L2 and the third optical element L3, and focuses images at the center of the image sensor IS. TA is the angle of the reflective surface with respect to a plane perpendicular to the optical axis incident on the reflective surface, as shown in FIG. 4-1.

The first lens group G of the imaging optical system consists of the first optical element L1. The first optical element L1 is a biconvex lens.

The second lens group G2 of the imaging optical system consists of the second optical element L2 and the third optical element L3. The second optical element L2 is a negative meniscus lens with a concave surface facing the object side. By applying an aspherical surface to the second optical element L2 and making a shape with a concave surface facing the object side, field curvature at the periphery of the image can be corrected satisfactorily. The third optical element L3 is a negative meniscus lens with a concave surface facing the object side.

In the fourth embodiment, the incident surface, the first reflective surface, the second reflective surface, and the light output surface of the prism P have curvatures. The light input incident surface is a rotationally asymmetric optical surface with a concave surface facing the object side. The first reflective surface is a rotationally asymmetric optical surface with a convex surface oriented toward the direction of the incoming light ray. The second reflective surface is a rotationally asymmetric optical surface with a convex surface oriented toward the direction of the incoming light ray. The output surface is a rotationally asymmetric optical surface with a concave surface facing the object side.

The prism P is composed of each optical surface having a curvature, which allows the prism P to have an optical power, shortening the overall optical length and lowering the prism height while maintaining optical performance. In addition, the first and second reflective surfaces are arranged inclined to the incident light ray, which causes rotationally asymmetric aberrations in rotationally symmetric optical surfaces. Therefore, by configuring each optical surface of the prism P with rotationally asymmetric optical surfaces, the rotationally asymmetric aberrations can be corrected, and a shorter overall optical length and lower profile can be expected. The rotationally asymmetric optical surfaces can be applied to some of the surfaces of the prism P, but it is desirable to apply rotationally asymmetric optical surfaces to two or more optical surfaces of the prism. The first and second reflective surfaces of the prism P may be formed by a metal (aluminum, silver, etc.) reflective film, a dielectric multilayer film, a metal reflective film with reflective coatings, or the like.

In the fourth embodiment, the chief ray entering from the light input surface of the prism P is reflected twice within the prism P, then self-intersects the chief ray path and is emitted from the light output surface, thereby resulting in a longer optical path within the prism. By increasing the total length within the prism, the distance from the light output surface of the prism to the image sensor can be shortened while maintaining high image quality.

Table 4-1 shows the radius of curvature and the thickness or separation for each of the optical surfaces, and the refractive index and the Abbe number with respect to the d line for each of the lens elements of the optical lens system in accordance with the fourth embodiment. Opposing surfaces of each lens element are respectively referred to as surface S1 and surface S2 in order from the object side to the image side. The opposing surfaces of the first optical element L1, the opposing surfaces of the second optical element L2, and the opposing surfaces of the third optical element L3 are aspherical. Further, in the first optical element L1, the absolute value of the radius of curvature of the object side surface S1 is smaller than the absolute value of the radius of curvature of the image side surface S2.

TABLE 4-1

| | | | | | | | | Clear | | |
|---|---|---|---|---|---|---|---|---|---|---|
| | | Surface | | | | | | Aperture | | Tilt |
| Lens | Surface | Type | Radius | Distance | Macro | Index | Abbe | X | Y | Angle |
| STO | | | INF | 0.000 | 0.068 | | | 5.390 | 4.040 | |
| L1 | S1 | Aspherical | 9.451 | 2.259 | | 1.569 | 71.341 | 5.390 | 4.040 | |
| | S2 | Aspherical | −49.975 | 0.215 | 0.732 | | | 5.316 | 3.850 | |
| Prism | S1 | Polynomial | INF | 6.316 | | 1.689 | 31.095 | 5.163 | 3.759 | |
| | S2 | Polynomial | INF | −6.375 | | | | 3.719 | 3.256 | 25.5 |
| | S3 | Polynomial | INF | 9.189 | | | | 2.517 | 2.014 | 19.5 |
| | S4 | Polynomial | INF | 1.359 | | | | 2.209 | 1.709 | |
| L2 | S1 | Aspherical | −8.729 | 0.504 | | 1.671 | 19.276 | 2.461 | 2.461 | |
| | S2 | Aspherical | −11.805 | 0.876 | 2.540 | | | 2.644 | 2.644 | |
| L3 | S1 | Aspherical | −4.426 | 1.163 | | 1.905 | 21.493 | 2.679 | 2.679 | |
| | S2 | Aspherical | −7.211 | 2.564 | 0.898 | | | 2.971 | 2.971 | |
| Corver | S1 | | INF | 0.110 | | 1.513 | 54.000 | 2.919 | 2.193 | |
| Glass | S2 | | INF | 0.410 | | | | 2.929 | 2.200 | |

| | | | | |
|---|---|---|---|---|
| Image Surface | INF | 0.000 | 2.994 | 2.244 |

Table 4-2 shows the aspheric coefficients for each of the lens elements of the optical lens system in accordance with the fourth embodiment, wherein numbers 4, 6, . . . , 12 represent the higher order aspheric coefficients.

TABLE 4-2

| | | Aspherical | | | | | |
|---|---|---|---|---|---|---|---|
| Lens | Surface | K | 4th | 6th | 8th | 10th | 12th |
| L1 | S1 | −3.0080E−02 | −2.7279E−05 | −1.0974E−06 | 1.7924E−08 | −6.4795E−10 | 7.2448E−13 |
| | S2 | 4.0068E+01 | −1.6221E−05 | 2.4792E−06 | 1.8762E−08 | −5.4032E−10 | 4.8212E−12 |
| L2 | S1 | 7.6671E+00 | −1.5978E−02 | 9.0741E−04 | −2.2472E−05 | −1.1426E−05 | 1.9084E−06 |
| | S2 | 0.0000E+00 | −1.4811E−02 | 8.1052E−04 | −3.0544E−05 | −3.3991E−06 | 5.4268E−07 |
| L3 | S1 | −1.4330E−01 | 4.7549E−03 | −3.7878E−04 | 2.6308E−05 | 2.0557E−06 | −1.5083E−07 |
| | S2 | −2.3890E−01 | 2.6069E−03 | −1.3668E−04 | 5.3315E−06 | 1.4297E−07 | 2.0495E−08 |

The light input surface, reflective surface, and light output surface of the prism in the telephoto imaging system of the fourth aspect are not planes but curved surfaces formed by the following polynomial.

$$Sag ( z ) = \frac{{cr}^{2}}{1 + \sqrt{1 - ( 1 + k ) {c}^{2} {r}^{2}}} + \sum {C}_{mn} {X}^{m} {Y}^{n}$$

wherein,
c: curvature;
r: radius (r=\sqrt{X²+Y²});
c: Uneven thickness curvature at the apex of the lens (reciprocal of radius of curvature);
X: the distance in the X direction from a point on the curve to the optical axis;
Y: the distance in the Y direction from a point on the curve to the optical axis;
k: the conic coefficient; and

$${C}_{mn} : Polynomial coefficient ( {C}_{mn} = {X}_{m} {Y}_{n} )$$

Table 4-3 shows the XY polynomials of each optical element of the telephoto imaging optical system according to the fourth embodiment.

FIG. 4-2 shows a longitudinal spherical aberration for each wavelength in the imaging optical system according to the fourth embodiment of the present disclosure. The fourth embodiment in this disclosure are designed with well-corrected spherical aberration and sufficiently suppressed axial chromatic aberration.

FIG. 4-3 shows a field curvature where the amount of d-line aberration on the sagittal image plane S and the amount of d-line aberration on the tangential image plane T are shown by a different line in the imaging optical system according to the fourth embodiment of the present disclosure. The field curvature is also well corrected in both the sagittal and tangential image planes.

FIG. 4-4 shows a distortion aberration with the amount of aberration for each wavelength. It shows that the distortion is also minimized. From these figures, it can be seen that each aberration is satisfactorily corrected.

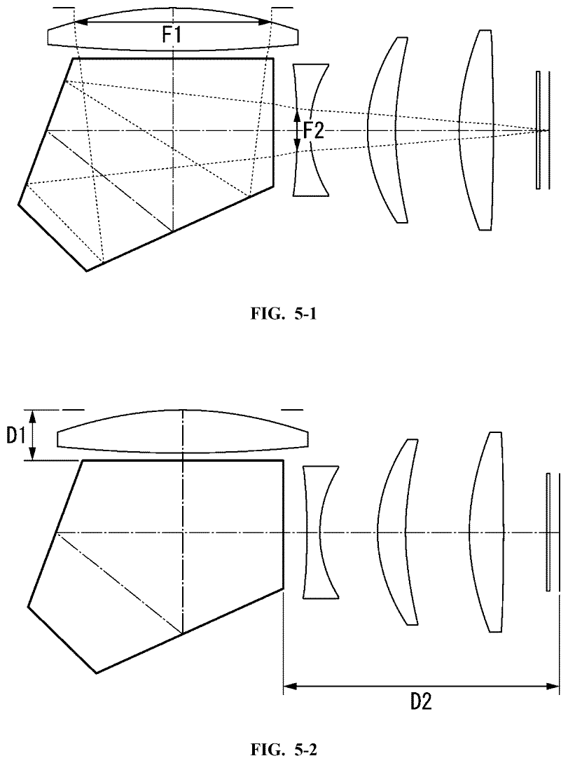

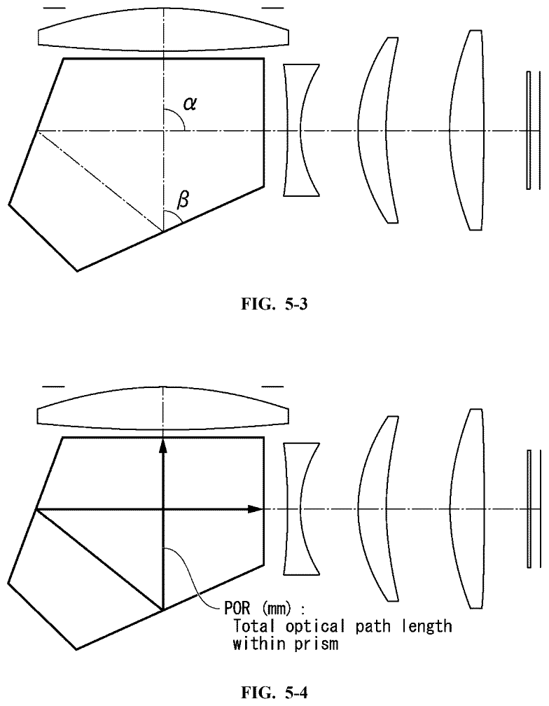

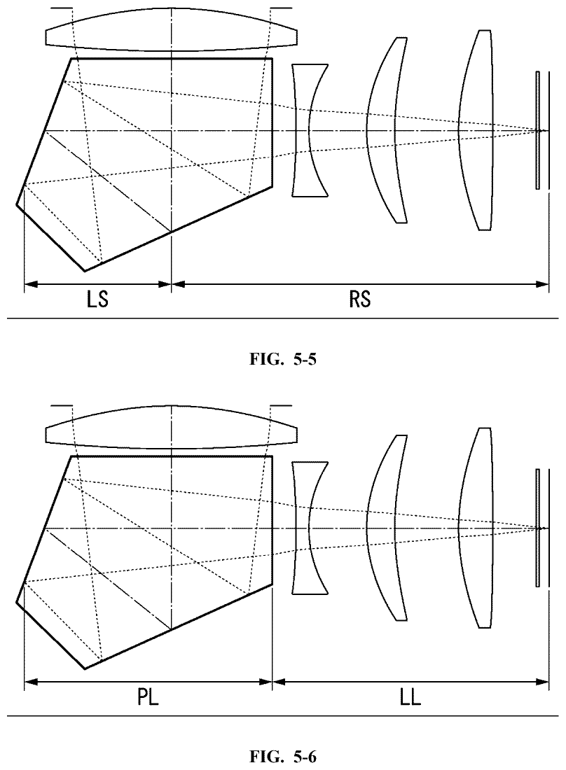

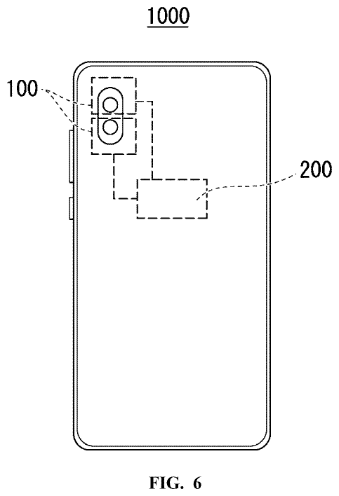

As shown in the optical data above, the telephoto imaging system of the present disclosure can achieve both high image quality and miniaturization while shortening the distance from the prism to the image sensor by increasing the optical path length in the prism. The telephoto imaging system of these embodiments can achieve a desirable effect by satisfying the following conditions.

$$1 < F 1 / F 2 ≦ 10 \qquad ( i )$$

where F1 is a maximum light flux diameter at the most object side optical surface (convex surface) of the first lens group, wherein the light ray focuses images at the center of the image sensor, and F2 is a maximum light flux diameter at the most object side optical surface in the second lens group, wherein the light ray focuses images at the center of the image sensor (see FIG. 5-1).

$$\vert R 1 \vert < \vert R 2 \vert \qquad ( ii )$$

where R1 is a radius of curvature of an object side surface of the most object side optical element in the first lens group, and R2 is a radius of curvature of an image side surface of the most object side optical element in the first lens group.

$$0 ≦ D 1 / D 2 < 1 \qquad ( iii )$$

where D1 is a distance from the light input surface of the prism to the aperture stop, and D2 is a distance from the light output surface of the prism to the image sensor (see FIG. 5-2).

$$α / 2 < β \qquad ( iv )$$

where α is an angle between the optical axis of the first lens group and the optical axis of the second lens group, and β is an angle between the optical axis of the first lens group and a first reflective surface where the light incident from the light input surface is first reflected (see FIG. 5-3).

$$ν d > 50 \qquad ( v )$$

where νd is the Abbe number of the optical material of the most object side optical element of the first lens group.

$$FOV < 40 ° \qquad ( vi )$$

where FOV is a full angle of view when the object distance is infinite.

$$0.2 ≦ POR / f ≦ 2. \qquad ( vii )$$

where POR is a total path length (mm) within the prism from the light input surface to the light output surface along the chief ray that focuses images at the center of the image sensor (see FIG. 5-4), and f is a focal length (mm) of the imaging optical system.

$$0.5 ≦ ( POR / Pn ) / f ≦ 3. \qquad ( viii )$$

where POR is a total path length (mm) within a prism from a light input surface to a light output surface, through which the chief ray that focuses images at the center of the image sensor passes (see FIG. 5-4), and Pn is a refractive index of the prism.

$$1 ≦ L 1 a / Pa \qquad ( ix )$$

where L1a is the Abbe number of the most object side optical element in the first lens group, and Pa is Abbe number of the prism.

$$0.5 ≦ \vert L 1 f / Ff \vert ≦ 2.5 \qquad ( x )$$

where L1 is a focal length (mm) of the most object side optical element in the first lens group, and Ff is a focal length of a movable group (mm) when the first lens group or the second lens group consists of one movable lens group or one movable lens group and one fixed lens group, wherein the movable lens group is movable along the optical axis for the focus adjustment.

$$0.2 ≦ LS / RS ≦ 1.5 \qquad ( xi )$$

where RS is a distance (mm) from the point where the chief rays self-intersect within the prism to the image sensor, and LS is a distance (mm) in the optical axis direction of the second lens group from the light output surface to the point farthest from the image sensor in the effective area of the prism, which is used by the light rays focusing images at the center of the image sensor (see FIG. 5-5).

$$0.5 ≦ PL / LL ≦ 3.5 \qquad ( xii )$$

where LL is a distance (mm) in the optical axis direction of the second lens group from the light output surface to the image sensor, and PL is a distance (mm) in the optical axis direction of the second lens group from the light output surface to the point farthest from the image sensor in the effective area of the prism, which is used by the light rays focusing images at the center of the image sensor (see FIG. 5-6).

The condition (i) defines the ratio of the maximum light flux diameter entering the prism to the maximum light flux diameter exiting the prism. When the condition (i) is satisfied, it is possible to shorten the overall length of the optical system while maintaining high optical performance. When condition (i) is less than the lower limit, it becomes difficult to maintain high optical performance because the distance between the light rays emitted from the prism and the image forming surface cannot be properly maintained and the second lens group cannot be arranged. If the upper limit of the condition (i) is exceeded, diverging rays of light emanate from the prism, and the prism and second lens group become larger, which is undesirable.

By satisfying the condition (ii), spherical aberration can be corrected satisfactorily and high optical performance can be expected.

The condition (iii) defines the height and length directions of the optical system. When the condition (iii) is satisfied, it is possible to shorten the overall length of the optical system while maintaining a low profile of the optical system. If the upper limit of the condition (iii) is exceeded, it becomes difficult to maintain high optical performance while maintaining the low profile of the optical system. In the embodiments above, a is 90°, but is not limited to this.

The condition (iv) defines the angle between the optical axis of the first lens group and the optical axis of the second lens group and the reflective surface of the prism. When the condition (iv) is satisfied, a low profile can be achieved while avoiding vignetting at the prism edge and reflective surface inside the prism. When the condition (iv) is not satisfied, a part of the light rays toward the light output surface of the prism interferes with the edge of the reflective surface where the light incident from the light input surface is first reflected, causing vignetting and ghost flare. If vignetting, etc., is avoided, the optical axis of the second lens group rotates in a semi-clockwise direction, making it difficult to lower the height of the entire optical system.

The condition (v) specifies the Abbe number of the optical element with a convex surface facing the object side. When the condition (v) is satisfied, the chromatic aberration generated by the first lens group can be corrected appropriately, and high optical performance can be maintained while the total length of the optical system is shortened. If the condition (v) is not satisfied, chromatic aberration is corrected in the second lens group, but the number of lenses increases, so this is not suitable for shortening the overall length of the optical system.

The condition (vi) defines the total angle of view FOV of the optical system. In a telephoto optical system that satisfies the condition (vi), a lower profile and shorter overall length of the optical system can be expected. If the condition (vi) is not satisfied, the aperture of the prism incidence surface becomes large, which is not desirable. greater effects can be expected by satisfying the following condition:

$$FOV < 30 ° \qquad ( vi - 1 )$$

More even greater effects can be expected by satisfying the following condition:

$$FOV < 20 ° \qquad ( vi - 2 )$$

The condition (vii) specifies the ratio of the total path length inside the prism to the focal length of the optical system. When the condition (vii) is satisfied, the optical path is bent inside the prism, enabling both miniaturization and high performance of the optical system. When the condition (vii) is less than the lower limit, the optical path inside the prism becomes shorter, and the effect of downsizing by bending the optical path cannot be expected. If the upper limit of the condition (vii) is exceeded, the optical path inside the prism becomes longer in relation to the focal length of the optical system, the distance between the light rays emitted from the prism and the image forming surface cannot be properly maintained, and the second lens group cannot be arranged, making it difficult to maintain high optical performance.

The condition (viii) specifies the ratio of the total path length inside the prism to the focal length of the optical system. When the condition (viii) is satisfied, the optical path is bent inside the prism and both miniaturization and high performance of the optical system can be achieved. When the condition (viii) is less than the lower limit, the optical path inside the prism becomes shorter, and the effect of downsizing by bending the optical path cannot be expected. If the upper limit of the condition (viii) is exceeded, the optical path inside the prism becomes longer in relation to the focal length of the optical system, the distance between the light rays emitted from the prism and the image forming surface cannot be properly maintained, and the second lens group cannot be arranged, making it difficult to maintain high optical performance.

The condition (ix) specifies the ratio of the Abbe number of the optical element on the most object side of the first lens group to the Abbe number of the prism. Satisfying the condition (ix) enables the optical system to be reduced in height and shortened in overall length, while correcting chromatic aberration satisfactorily. If the condition (ix) is not satisfied, it becomes difficult to correct chromatic aberration while maintaining a low profile and shortening the overall length of the optical system.

The condition (x) defines the ratio of the focal length of the first lens group to the focal length of the focus group. When the condition (x) is satisfied, the movable range of the movable group can be appropriately set, and the overall length of the optical system can be expected to be shortened while maintaining optical performance during focusing. If the lower limit of the condition (x) is exceeded, the focus adjustment amount of the operating group becomes large, making it difficult to shorten the total length of the optical system. If the upper limit of the condition (x) is exceeded, it is not preferable because high precision is required for focus adjustment of the operating group and the focus mechanism becomes large.

The condition (xi) defines the arrangement of the prism and the second lens group relative to the optical axis of the first lens group. When the condition (xi) is satisfied, the optical system can be made low profile while maintaining high optical performance. When the lower limit of the condition (xi) is surpassed, the height direction of the prism needs to be widened to avoid interference between the light rays and the reflective surface inside the prism, and when the upper limit of the condition (xi) is exceeded, the height direction of the prism needs to be widened to avoid interference between the light rays and the reflective surface inside the prism as well.

The condition (xii) specifies the ratio of the length of the prism to the length from the prism to the image forming surface including the second lens group in the optical axis direction of the second lens group. When the condition (xii) is satisfied, the total length of the optical system can be shortened while appropriate optical elements are placed in the second lens group and high optical performance can be maintained. When the condition (xii) is less than the lower limit, the diameter of the light flux incident from the first lens group to the prism becomes small, resulting in a dark optical system. If the upper limit of the condition (xii) is exceeded, it is difficult to maintain high optical performance because the distance between the light ray emitted from the prism and the image forming surface cannot be properly maintained and the second lens group cannot be placed.

Table 5 shows the specifications used in the above-mentioned conditions from the first, second, third, and fourth embodiments.

TABLE 5

| | Embodiment | Embodiment | Embodiment | Embodiment |
|---|---|---|---|---|
| | 1 | 2 | 3 | 4 |
| Image hight (mm) | 3.57 | 3.57 | 3.57 | 3.57 |
| f (mm) | 33.12 | 33.03 | 33.07 | 33.08 |
| Fno | 3.50 | 3.31 | 3.49 | 3.32 |
| Macro (mm) | 1000.00 | 10000.00 | 1000.00 | 10000.00 |
| TTL (mm) | 21.50 | 18.10 | 21.00 | 16.86 |
| L1R1 R (mm) | 14.32 | 12.51 | 14.04 | 9.45 |
| L1 Index | 1.54 | 1.57 | 1.50 | 1.57 |
| L1a | 55.99 | 71.34 | 81.56 | 71.34 |
| (L1 Abbe number) | | | | |
| Pn | 1.75 | 1.67 | 1.91 | 1.69 |
| (Prism Index) | | | | |
| Pa | 25.05 | 58.96 | 35.25 | 31.09 |
| (Prism abbe number) | | | | |
| POR | 23.20 | 22.26 | 35.80 | 21.88 |
| (Prism Optical Route) | | | | |
| POR/Pn | 13.24 | 13.32 | 18.74 | 12.96 |
| AF Group Focal Length (mm) | 10.66 | 15.64 | 23.36 | −15.81 |
| AF Stroke (mm) | 1.35 | 2.24 | 0.53 | 1.66 |
| L1 f | 20.14 | 17.27 | 23.36 | 14.16 |
| L2 f | −6.55 | −90.28 | −10.55 | −53.41 |
| L3 f | 24.58 | −7.90 | 33.16 | −15.81 |
| L4 f | 15.73 | 15.64 | — | — |
| LS | 6.20 | 5.60 | 10.45 | 5.64 |
| RS | 15.30 | 12.50 | 10.55 | 11.22 |
| PL | 10.26 | 9.82 | 15.26 | 9.88 |
| LL | 11.24 | 8.29 | 5.74 | 6.98 |

Table 6 shows the values of the parameters used in the above-mentioned conditions (i) to (xii) of the first, second, third, and fourth embodiments.

TABLE 6

| | Embodiment | Embodiment | Embodiment | Embodiment |
|---|---|---|---|---|
| | 1 | 2 | 3 | 4 |
| F1 | 10.00 | 10.78 | 10.00 | 10.78 |
| F2 | 2.32 | 1.61 | 1.28 | 1.61 |
| F1/F2 | 4.31 | 6.68 | 7.79 | 6.68 |
| D1 | 2.17 | 0.80 | 2.29 | 2.47 |
| D2 | 11.24 | 3.44 | 5.74 | 6.99 |
| D1/D2 | 0.19 | 0.23 | 0.40 | 0.35 |
| α | 90.00 | 90.00 | 90.00 | 90.00 |
| α/2 | 45.00 | 45.00 | 45.00 | 45.00 |
| β | 65.00 | 64.36 | 70.00 | 64.50 |
| L1a | 55.99 | 71.34 | 81.56 | 71.34 |
| α | 90.00 | 90.00 | 90.00 | 90.00 |
| FOV | 12.31 | 12.34 | 12.32 | 12.32 |
| POR/f | 0.70 | 0.67 | 1.08 | 0.66 |
| (POR/Pn)/f | 0.40 | 0.40 | 0.57 | 0.39 |
| L1a/Pa | 2.24 | 1.21 | 2.31 | 2.29 |
| \| L1f/Ff \| | 1.89 | 1.10 | 1.00 | −0.90 |
| LS/RS | 0.41 | 0.45 | 0.99 | 0.50 |
| PL/LL | 0.91 | 1.18 | 2.66 | 1.42 |

By satisfying these conditions, the imaging optical system of present disclosure can be miniaturized to a size that can be installed in mobile devices, and since the TTL is not changed, image quality is not sacrificed, nor are complex and effective optical elements used, and a more compact imaging optical system module than the conventional periscope type is achieved. For the telephoto lenses, which has a long focal lengths, the imaging optical system of present disclosure enables installation in a compact housing space while compactly configuring an optical system applying a large aperture and a large image sensor.

In the above-mentioned embodiments, the aperture stop is arranged parallel to the light input surface of the prism, but it is also understood that the aperture stop may be arranged parallel to the light output surface of the prism for use at a wider angle side. By arranging the aperture stop on the object side of the prism, the width of the prism optical path, including the entire view angle, can be consolidated, contributing to downsizing the entire prism. Also, by arranging the aperture stop on the most object side optical surface (convex side), the lens barrel configuration can be simplified and unwanted light, which causes ghosting and flare, can be eliminated. However, even when the aperture stop is arranged on the prism side rather than the most object side optical surface, the effect of the present disclosure can be expected.

In the imaging optical system of the present disclosure, it is preferred that the aperture stop is positioned on the object side from the prism. Furthermore, it is also preferred that the aperture stop is positioned on the most object side optical surface (convex surface) of the first lens group. By having the concave surface on the most object side optical surface of the second lens group toward the light output surface of the prism, it is expected to reduce image curvature and is also expected to be effective in correcting spherical aberration generated by the first lens group. Furthermore, by applying an aspheric surface to the concave surface, the above correction effect can be expected to be further enhanced. In such a case, it is desirable that the aspheric surface shape toward the periphery of the effective diameter has a concave surface toward the light output surface of the prism.

In the imaging optical system of the present disclosure, the second lens group has at least one optical element having a negative refractive power, and it is preferred that the most object side optical surface of the second lens group has a concave surface facing the light output surface of the prism.

In the imaging optical system of the present disclosure, focus adjustment is possible by moving some of the optical elements in the optical axis direction as described above.

In the imaging optical system of the present disclosure, image stabilization is possible by configuring the first lens group and/or the prism to be rotatable around at least one of the optical axis of the first lens group, the optical axis of the second lens group, and an axis perpendicular to the optical axes of the first lens group and the second lens group. Image stabilization is also possible by moving the image sensor in a plane perpendicular to the second optical axis (xy-plane) in the x-direction and/or in the y-direction and/or in the direction of rotation around the second optical axis. In such a case, the first lens group and/or the prism may be fixed or may be rotated simultaneously with the movement of the image sensor. When the first lens group and/or the prism are rotated simultaneously with the movement of the image sensor, the correction range of image stabilization may be expected to be extended.

In the imaging optical system of the present disclosure, focusing may be performed by moving the entire second lens group along the optical axis. In this case, the mechanism for holding and driving the optical elements of the second lens group can be simplified and the lens barrel configuration can be simplified.

In the imaging optical system of the present disclosure, the optical surface or part of each optical element or aperture diaphragm A that constitutes the imaging optical system may have an effective diameter that is rotationally asymmetric with respect to the optical axis. In such a case, the imaging optical system can be expected to be downsized by cutting a part of the optical element (so-called I-cut or D-cut).

In the imaging optical system of the present disclosure, when flat glass, resin, etc. are placed on the object side of the first lens group for the purpose of dustproofing and protecting the optical system, these non-refractive optical elements are not included in the most object side optical surface.

Furthermore, terminals such as smartphones and cameras are provided. The terminal of the present disclosure comprises the imaging optical system of the present disclosure and a Graphic Processing Unit (GPU). The imaging optical system is configured to input light, which is used to project an image onto the image sensor, and the image sensor is configured to convert the image into digital image data. The GPU is connected to the imaging optical system and receives and processes image signals.

In FIG. 6, the terminal 1000 is configured with two imaging optical systems 100. However, a terminal may consist of a single camera or two or more imaging optical systems, which may be connected to a single GPU 200. One of the imaging optical systems 100 can be combined with the imaging optics of the present disclosure, and the other camera 100 can be combined with a different type of optics, such as a single focal wide angle lens.

Although the imaging optical system according to the present disclosure can be applied especially to mobile phone cameras, it can also be applied to cameras in any mobile device such as tablet-type devices and wearable devices.

Although preferred embodiments of the present disclosure have been disclosed for illustrative purposes, those skilled in the art will appreciate that various modifications, additions, and substitutions are possible, without departing from the scope and spirit of the disclosure as disclosed in the accompanying claims.

What is claimed is:

1. An imaging optical system comprising:
from an object side to an image side along an optical axis,
a first lens group having a convex surface on a most object side;
a prism comprising:
a light input surface at which light that has passed through the first lens group is incident;
a plurality of reflective surfaces that reflect incident light; and
a light output surface from which the light reflected from a last reflective surface of the plurality of reflective surfaces is emitted,
wherein the plurality of reflective surfaces are arranged so that a chief ray incident from the light input surface is reflected multiple times within the prism so as to self-intersect a chief ray path at least once within the prism;
a second lens group comprising at least one optical element having negative refractive power; and
an image sensor on which the light that has passed through the second lens group focuses images,
wherein following condition is satisfied:
$$1 < F 1 / F 2 ≦ 10$$
where F1 is a maximum light flux diameter at an optical surface of the most object side of the first lens group, wherein a light ray focuses images at a center of the image sensor, and F2 is a maximum light flux diameter at an optical surface of the most object side in the second lens group, wherein the light ray focuses images at a center of the image sensor.

2. The imaging optical system according to claim 1, further comprising an aperture stop closer to the object side than the prism.

3. The imaging optical system according to claim 2, wherein the aperture stop is arranged on the object side of said convex surface.

4. The imaging optical system according to claim 1, wherein following condition is satisfied:
$$\vert R 1 \vert < \vert R 2 \vert$$
where R1 is a radius of curvature of an object side surface of an optical element of the most object side in the first lens group, and R2 is a radius of curvature of an image side surface of an optical element of the most object side in the first lens group.

5. The imaging optical system according to claim 1, wherein an optical surface on the most object side of the second lens group has a concave surface facing the light output surface of the prism.

6. The imaging optical system according to claim 2, wherein following condition is satisfied:
$$0 ≦ D 1 / D 2 < 1$$
where D1 is a distance from the light input surface of the prism to the aperture stop, and D2 is a distance from the light output surface of the prism to the image sensor.

7. The imaging optical system according to claim 1, wherein following condition is satisfied:
$$α / 2 < β$$
where α is an angle between the optical axis of the first lens group and the optical axis of the second lens group, and β is an angle between the optical axis of the first lens group and a first reflective surface where light incident from the light input surface is first reflected.

8. The imaging optical system according to claim 1, wherein the imaging optical system comprises a single prism.

9. The imaging optical system according to claim 1, wherein an optical element of the most object side in the first lens group is formed of an optical material having an Abbe number νd of more than 50.

10. The imaging optical system according to claim 2, wherein the aperture stop and the light input surface of the prism are arranged parallel to each other.

11. The imaging optical system according to claim 1, wherein an angle α between the optical axis of the first lens group and the optical axis of the second lens group is 90°.

12. The imaging optical system according to claim 1, wherein a number of the plurality of reflective surfaces of the prism is two, or three.

13. The imaging optical system according to claim 1, wherein part or all of optical elements of the second lens group are movable along the optical axis of the second lens group.

14. The imaging optical system according to claim 1, wherein the second lens group includes a movable group, or a movable group and a fixed group, and a focus adjustment is performed by moving the movable group along the optical axis of the second lens group; or
wherein the first lens group includes a movable group, or a movable group and a fixed group, and a focus adjustment is performed by moving the movable group along the optical axis of the first lens group.

15. The imaging optical system according to claim 1, wherein the first lens group and the prism are both configured to be rotatable around at least one of the optical axis of the first lens group, the optical axis of the second lens group, and an axis perpendicular to the optical axis of the first lens group and the optical axis of the second lens group.

16. The imaging optical system according to claim 1, wherein the following condition is satisfied:
$$FOV < 40 °$$
where FOV is a full angle of view when a object distance is infinite.

17. The imaging optical system according to claim 1, wherein following condition is satisfied:
$$0.2 ≦ POR / f ≦ 2.0$$
where POR is a total path length (mm) within the prism from the light input surface to the light output surface along a chief ray that focuses images at the center of the image sensor, and f is a focal length (mm) of the imaging optical system; or
$$0 \text{.5} ≦ ( POR / Pn ) / f ≦ 3.$$
where POR is a total path length (mm) within a prism from a light input surface to a light output surface, through which the chief ray that focuses images at the center of the image sensor passes, and Pn is a refractive index of the prism; or
$$1 ≦ L 1 a / Pa$$
where L1a is an Abbe number of an optical element of the most object side in the first lens group, and Pa is an Abbe number of the prism.

18. The imaging optical system according to claim 14, wherein the following condition is satisfied:
$$0 \text{.5} ≦ \vert L 1 f / Ff ≦ 2. 5 ( x )$$
where L1 is a focal length (mm) of an optical element of the most object side in the first lens group, and Ff is a focal length of a movable group (mm) when the first lens group or the second lens group includes a movable lens group or a movable lens group and a fixed lens group, wherein the movable lens group is movable along the optical axis for a focus adjustment.

19. The imaging optical system according to claim 1, wherein following condition is satisfied:
$$0.2 ≦ LS / RS ≦ 1.5$$
where RS is a distance (mm) from a point where the chief ray self-intersects within the prism to the image sensor, and LS is a distance (mm) in an optical axis direction of the second lens group from the light output surface to a point farthest from the image sensor in an effective area of the prism, which is used by light beams focusing images at the center of the image sensor; or
$$0.5 ≦ PL / LL ≦ 3.5 \qquad ( xii )$$
where LL is a distance (mm) in the optical axis direction of the second lens group from the light output surface to the image sensor, and PL is a distance (mm) in the optical axis direction of the second lens group from the light output surface to the point farthest from the image sensor in the effective area of the prism, which is used by the light beams focusing images at the center of the image sensor.

20. A terminal comprising:
an imaging optical system, from an object side to an image side along an optical axis, comprising:
a first lens group having a convex surface on a most object side;
a prism comprising:
a light input surface at which light that has passed through the first lens group is incident;
a plurality of reflective surfaces that reflect incident light; and
a light output surface from which the light reflected from a last reflective surface of the plurality of reflective surfaces is emitted,
wherein the plurality of reflective surfaces are arranged so that a chief ray incident from the light input surface is reflected multiple times within the prism so as to self-intersect a chief ray path at least once within the prism;
a second lens group comprising at least one optical element having negative refractive power;
an image sensor on which the light that has passed through the second lens group focuses images,
wherein following condition is satisfied:
$$1 < F 1 / F 2 ≦ 10$$
where F1 is a maximum light flux diameter at an optical surface of the most object side of the first lens group, wherein a light ray focuses images at a center of the image sensor, and F2 is a maximum light flux diameter at an optical surface of the most object side in the second lens group, wherein the light ray focuses images at a center of the image sensor; and
a Graphic Processing Unit (GPU), wherein the GPU is connected to the imaging optical system and receives and processes image signals.
